(19) United States
(12) Patent Application Publication
(10) Pub. No.: US 2014/0244825 A1
(43) Pub. Date: Aug. 28, 2014

(54) INTELLIGENT MANAGEMENT SYSTEM FOR HOUSEHOLD INTERNET OF THINGS

(71) Applicants: Qingrui Cao, Changchun (CN); Xin Gao, Changchun (CN)

(72) Inventors: Qingrui CAO, Changchun (CN); Xin Gao, Changchun (CN)

(21) Appl. No.: 14/271,635

(22) Filed: May 7, 2014

Related U.S. Application Data
(63) Continuation of application No. PCT/CN2012/001284, filed on Sep. 20, 2012.

(30) Foreign Application Priority Data
Nov. 7, 2011 (CN) 201120436879.6

(51) Int. Cl. H04L 12/24

(52) U.S. Cl. CPC H04L 41/0246; H04L 41/18
USPC 709/223

(57) ABSTRACT

A computer control system and an intelligent management system is provided for a household Internet of Things. The intelligent management system includes an intelligent management server for a household Internet of Things system, control devices, in-house functional units, outside functional department servers and outside service department servers. The intelligent management server for the household Internet of Things system is wiredly or wirelessly communicated with the control device, the in-house functional units, the outside functional department servers and the outside service department servers respectively. According to embodiments, the system promptly and centrally controls the in-house functional units, and promptly communicates with the outside functional department servers and the outside service department servers, thus saving resources, consuming transparently, handling affairs quickly, facilitating service and ensuring security.

### CROSS-REFERENCE TO RELATED APPLICATIONS

This is a Continuation Application of International Application No. PCT/CN2012/001284, filed on Sep. 20, 2012, which claims priority on Chinese Patent Application No. 201120436879.6, filed on Nov. 7, 2011. The contents of the aforementioned applications are incorporated herein by reference.

### BACKGROUND

1. Field

The present utility model relates to a computer control system, especially relates to an intelligent management system for a household Internet of Things.

2. Description of the Related Art

Prior to the present utility model, various in-house functional units can not be well centrally managed, and the communication between the outside functional department and the outside service department are not very good. So firstly, it's a waste of electricity, water, heat and gas due to the household products can not be controlled promptly. Secondly, once there are some problems at home, we can not communicate with the related department to solve them, so it is likely to cause irreparable loss. Thirdly, the present family does not possess the condition of working, shopping or handling at home. If we can not achieve the aim of sharing and interacting the information about working, shopping or communicating with the functional department and the service department promptly, it is not convenient to fulfill the corresponding tasks of shopping, working and handling at home.

### SUMMARY

An object of the present utility model is to provides an intelligent management system for a household Internet of Things, so the intelligent management system can promptly and centrally controls the in-house functional units, and promptly communicates with the outside functional department servers and the outside service department servers, thus saving resources, consuming transparently, handling affairs quickly, facilitating service and ensuring security.

To achieve the object mentioned above, the present utility model comprises technical solutions as follows:

The present utility model relates to an intelligent management system for a household Internet of Things. The intelligent management system comprises an intelligent management server for a household Internet of Things system, control devices, in-house functional units, outside functional department servers and outside service department servers. The intelligent management server for the household Internet of Things system is wiredly or wirelessly communicated with the control devices, the in-house functional units, the outside functional department servers and the outside service department servers respectively.

Wherein, the control devices comprise mobile-phones, computers, remote-controllers and vehicle-mounted devices.

Wherein, the in-house functional units comprise gas pipeline control solenoid valves, tap water pipeline control solenoid valves, electric-circuit control switches, hot air pipeline control solenoid valves, fire sprinkler control switches, household appliances control switches, doors and windows sensors and cameras.

Wherein, the outside service department servers comprise Public Security Department servers, Fire Department servers, Medical Institutions servers, Banking Department servers, Heating Company servers, Gas Company servers, Electric Power Company servers, Tap Water Company servers.

Wherein, the outside service department servers comprise property management company servers, malls and supermarkets servers, catering company servers, intermediary company servers.

Wherein, the intelligent management server for a household Internet of Things system comprises a memory unit, a decoding circuit, a data processing unit, a drive circuit, a wireless signal transceiver unit, several touch control displays and network interfaces. The data processing unit is communicated with the memory unit, the decoding circuit, the data processing unit, the drive circuit, the wireless signal transceiver unit and the several touch control displays. The touch control displays are used to mount on walls, tables, doors of the refrigerators, ground and cookers table-boards.

With the above mentioned technical solutions, the advantages of the present utility model are as follows:
1. The present utility model can promptly and centrally control the in-house functional units and directly show the service conditions and power consuming conditions of the in-house functional units on the touch control displays of the intelligent management server for a household Internet of Things system, thus consuming transparently and saving resources.
2. The present utility model can promptly communicate with the outside functional department and the outside service department, thus handling affairs quickly, facilitating service and ensuring security.
3. The present utility model can also interactively communicate with several touch control displays in different places at home, thereby sharing the information in the family and building a complete household Internet of Things system, so it brings the family life more convenience. For example, the touch control displays can be applied on walls, tables, doors of the refrigerators, door of the house, ground and cookers table-boards. One can operate, interact, check and run the touch control displays at everyplace of the house.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an exemplary block diagram of an embodiment according to the invention.

### DETAILED DESCRIPTION

The following embodiments are used to explain the present utility model, rather than limit the scope of the present utility model.

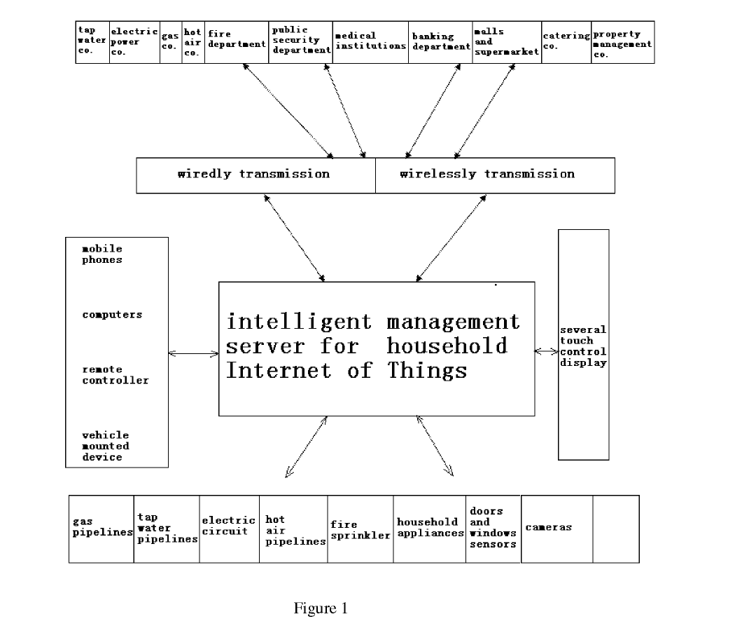

As shown in FIG. 1, according to embodiments of the present invention, there is provided an intelligent management system for a household Internet of Things. The intelligent management system comprises an intelligent management server for a household Internet of Things system, control devices, in-house functional units, outside functional department servers and outside service department servers. Wherein, The intelligent management server for the household Internet of Things system is wiredly or wirelessly communicated with the control devices, the in-house functional units, the outside functional department servers and the outside service department servers respectively. The wiredly connection comprises the Internet, the Cable TV network, the telephone network, the Wire network, and the wirelessly connection comprises the wireless Local Area Network and the Radio Mobile Network.

The intelligent management server for a household Internet of Things system comprises a memory unit, a decoding circuit, a data processing unit, a drive circuit, a wireless signal transceiver unit, several touch control displays and network interfaces. The data processing unit is communicated with the memory unit, the decoding circuit, the data processing unit, the drive circuit, the wireless signal transceiver unit and the several touch control displays. The touch control displays are used to mount on walls, tables, doors of the refrigerators, ground and cookers table-boards.

The control units comprise mobile-phones, computers, remote-controllers and vehicle-mounted devices.

The in-house functional units comprise gas pipeline control solenoid valves, tap water pipeline control solenoid valves, electric-circuit control switches, hot air pipeline control solenoid valves, fire sprinkler control switches, household appliances control switches, doors and windows sensors and cameras.

The outside service department servers comprise Public Security Department servers, Fire Department servers, Medical Institutions servers, Banking Department servers, Heating Company servers, Gas Company servers, Electric Power Company servers, Tap Water Company servers.

The outside service department servers comprise property management company servers, malls and supermarkets servers, catering company servers, intermediary company servers and the like company servers for family service.

The intelligent management server for a household Internet of Things system of the present utility model is the heart of the system, with help of the intelligent management server, the system performs the function of gathering the system information, inputting the information, outputting the information, centrally controlling, remote-controlling and gang-controlling, etc. The function of the system generally comprises the family security, the medical rescue service, the fire monitoring rescue, the UnionPay services, the visual intercom, the remote meter-reading, the remote pipeline control, the home appliances control, the home information services and the value-added services and other services. The present utility model can remote control the intelligent management server for a household Internet of Things system through mobile phones, computers, remote-controllers and vehicle-mounted devices, and can achieve the information exchange among the mobile phones, the computers, the remote-controllers and the vehicle-mounted devices through the intelligent management server for a household Internet of Things system, thereby providing more conveniently service functions for the masters.

The present utility model integrates all the functions of the home intelligentization and builds the household Internet of Things system on a uniform platform. Firstly, it performs the data exchange between the in-house network and the outside network; secondly, it ensures to identify the instructions input from the network transmission is the legal instructions rather than the illegal invasions by Hackers. Therefore, the present utility model is not only the transportation junction of the home information but also the patron saint of the informational family.

The wirelessly transmission, in a consumption way, shows the consumption on the touch control displays in real-time, so the consumers can consume the energy resource transparently, reduce the unnecessary waste consciously and save the energy. The present utility model replaces the existing water meter, electricity meter, gas meter and hot air meter and achieves the function of combining the several meters in one, thereby saving a large amount of resource for the country.

The present utility model can achieve the function of remote controlling through the control units and promptly control each pipeline switch, thereby providing strong guarantee for the family security.

Comparing to the conventional home furnishing of the prior art, the present utility model not only possesses the control function of the conventional living furnishing, thereby providing a comfort, safety and high grade pleasant living space, but also transforms the passivity static or discrete control structures of the prior art to a tool with the active intelligence, thereby helping the family and outside to keep the information communication fluently and optimizing people's living style, even saving the fund for each energy expenditure. The basic aim of the present utility model is to communicate the various information related communication devices, household appliances and family security means at home with a family intelligence system through wired or wireless ways to centrally or remotely monitor, control and home transactionally manage, thereby keeping the harmoniousness and harmony between these household equipments and the residential environment.

Apparently, the above mentioned embodiment of the present utility model is only to clearly explain the example of the present utility model, rather than limit the implement of the present utility model. As to an ordinary person skilled in the art, the present utility model can be modified and changed or altered variously in different ways on the foundation of the explanation mentioned-above. We can not provide exhaustivity for all implements in the description. Whatever in the range of the spirit and principle of the present utility model, any modification, equivalent replacement or improvement is all contained within the scope of the protection of the present utility model.

What is claimed is:

1. An intelligent management system for a household Internet of Things, the character is that:
the intelligent management system comprises an intelligent management server for a household Internet of Things system, control devices, in-house functional units, outside functional department servers and outside service department servers,
the intelligent management server for the household Internet of Things system is wiredly or wirelessly communicated with the control devices, the in-house functional units, the outside functional department servers and the outside service department servers respectively.

2. An intelligent management system for a household Internet of Things according to claim 1, the character is that:
the control devices comprise mobile-phones, computers, remote-controllers and vehicle-mounted devices.

3. An intelligent management system for a household Internet of Things according to claim 1, the character is that:
the in-house functional units comprise gas pipeline control solenoid valves, tap water pipeline control solenoid valves, electric-circuit control switches, hot air pipeline control solenoid valves, fire sprinkler control switches, household appliances control switches, doors and windows sensors and cameras.

4. An intelligent management system for a household Internet of Things according to claim 1, the character is that:
the outside service department servers comprise Public Security Department servers, Fire Department servers, Medical Institutions servers, Banking Department servers, Heating Company servers, Gas Company servers, Electric Power Company servers, Tap Water Company servers.

5. An intelligent management system for a household Internet of Things according to claim 1, the character is that:
the outside service department servers comprise property management company servers, malls and supermarkets servers, catering company servers, intermediary company servers.

6. An intelligent management system for a household Internet of Things according to claim 1, the character is that:
the intelligent management server for a household Internet of Things system comprises a memory unit, a decoding circuit, a data processing unit, a drive circuit, a wireless signal transceiver unit, several touch control displays and network interfaces,
the data processing unit is communicated with the memory unit, the decoding circuit, the data processing unit, the drive circuit, the wireless signal transceiver unit and the several touch control displays,
the touch control displays are used to mount on walls, tables, doors of the refrigerators, ground and cookers table-boards.
